(19) United States
(12) Patent Application Publication
(10) Pub. No.: US 2012/0242489 A1
(43) Pub. Date: Sep. 27, 2012

(54) Method and Computer Program Product for Processing Chromatograms Obtained by a Process Gas Chromatograph

(75) Inventors: Aosheng WANG, Eden Prairies, MN (US); Ray Dean Shepherd, Tulsa, OK (US)

(73) Assignee: Siemens Aktiengesellschaft, Munchen (DE)

(21) Appl. No.: 13/072,036

(22) Filed: Mar. 25, 2011

(51) Int. Cl. G08B 17/10; G01N 30/02

(52) U.S. Cl. 340/632; 73/23.36; 73/23.35

(57) ABSTRACT

The invention relates to a method for processing chromatograms obtained by a process gas chromatograph in a plurality of subsequent measurements of a process stream. To reduce the computational effort and time while maintaining high accuracy, the method comprises collecting a set of chromatograms from a predefined number of subsequent measurements, selecting one of the chromatograms of the set as a reference chromatogram, aligning solely by cross-correlation and shifting each other of the collected chromatograms to the selected chromatogram, performing a multivariate analysis on the aligned chromatograms to extract systematic information, performing, based on the information, a peak analysis on the latest chromatogram of the set and outputting the result of the peak analysis, and for a new measurement, excluding the chromatogram of the oldest measurement from the set of chromatograms, including the chromatogram from the new measurement and continuing with the step of selecting one of the chromatograms of the set as a reference chromatogram

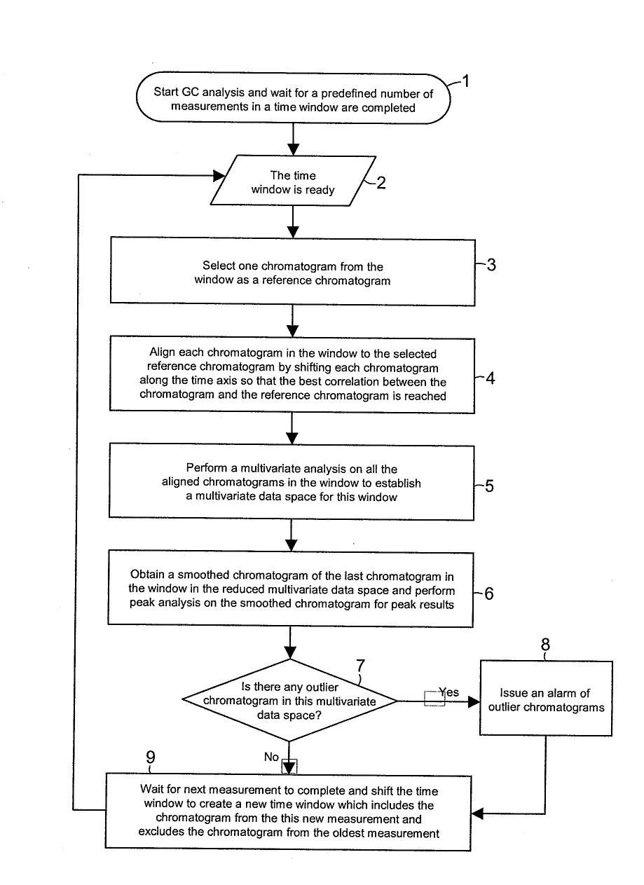

### BACKGROUND OF THE INVENTION

1. Field of the Invention

The invention relates to a method for processing chromatograms obtained by a process gas chromatograph in a plurality of subsequent measurements of one and the same process stream.

It further relates to a computer program product for processing such chromatograms.

2. Description of the Related Art

Process gas chromatographs (PGCs) are often used to continuously monitor a chemical or petrochemical process where chemical composition of the process as measured by PGCs are expected to be stable or to fluctuate only within narrow ranges of chemical concentrations in order for products of the process to have good product qualities or to comply with product regulations. Therefore, when a process of this kind is controlled properly, chromatograms obtained from each successive PGC measurement of a process stream carry very similar and highly redundant process information.

Thus, based on principles of multivariate statistics, the chromatograms from multiple successive PGC measurements of the same process stream could be analyzed together to establish a multivariate data space where the similar and redundant information from each measurement can be combined to reduce chromatogram noises that are inherent in each measurement and thereby to improve the precisions of chemical measurements. In addition, undesired process deviations from a normal chemical composition of the process stream can be more easily and reliably detected in this multivariate data space than in individual chromatograms analyzed separately.

Unfortunately, because of small short-term fluctuations of temperature and pressure in PGCs, the retention times of chromatogram peaks often shift around their normal positions in the chromatograms, and because of inherent long-term degradation of separation columns in PGCs, peak shapes can also change over time. Both retention and peak shape changes will change the chromatogram distribution in the associated multivariate space, which makes most multivariate analyses of successive PGC chromatograms virtually impossible.

In order to take advantages of multivariate analysis, many chromatogram alignment algorithms, such as dynamic time warping (DTW) and correlation optimized warping (COW), have been reported trying to warp chromatograms and then to align the warped chromatograms to a target chromatogram, hoping these warped and aligned chromatograms can be used to restore the original chromatogram distribution in the multivariate space. These warping algorithms, however, often require extensive computation resources, making it difficult to embed these algorithms in a PGC analyzer itself. More importantly, large peak shape changes that are inevitable due to separation column degradation can either increase computation time for warping significantly or fail the warping algorithms.

### SUMMARY OF THE INVENTION

It is therefore an object of the invention to reduce the computational effort and time while maintaining high accuracy in processing chromatograms obtained by a process gas chromatograph.

According to the invention this object is achieved by the initially mentioned method comprising the steps of:

collecting a set of chromatograms from a predefined number of subsequent measurements,

selecting one of the chromatograms of the set as a reference chromatogram,

aligning solely by cross-correlation and shifting each other of the collected chromatograms to the selected chromatogram,

performing a multivariate analysis on the aligned chromatograms to extract systematic information,

performing, on the basis of said information, a peak analysis on the latest chromatogram of the set and outputting the result of the peak analysis, and

for a new measurement, excluding the chromatogram of the oldest measurement from the set of chromatograms, including the chromatogram from the new measurement and continuing with the step of selecting one of the chromatograms of the set as a reference chromatogram.

The above-referenced object of the invention is further achieved by a computer program product arranged for causing a processor of a computer to execute this method.

Instead of using a warping-based algorithm to align chromatograms to an original target chromatogram, the invention uses a simple correlation-based algorithm to align multiple chromatograms in a short moving time window to a reference chromatogram that is automatically selected from other chromatograms in each window. The time window includes a set of chromatograms from a predefined number of the current and previous measurements. After alignment of chromatograms in the window, the window is moved to become a new time window which excludes the chromatogram from the oldest measurement and includes the chromatogram from the new measurement. The time window is made short enough to ensure there is little peak shape changes during this time, so that all the chromatograms in the window can be aligned by simple correlation and shifting without the need to warp the chromatograms.

An independent multivariate analysis, such as principal component analysis (PCA), is performed in each time window to reduce the dimension of data without losing information, i.e. to extract systematic information of the aligned chromatograms. On the basis of this information, a peak analysis on the most recent chromatogram is performed, and the result of the peak analysis is displayed.

As the time window is selected short enough to ensure there will not be significant peak shape changes in the window, the multivariate analysis will detect any chromatograms in the window with unexpected changes in peak shapes as outliers. In this case an alarm may be generated to provide an early warning of a possible process upset or an analyzer malfunction.

The selection of the time length of the moving time window or of the number of measurement cycles included in the window is highly application specific. However, in order to satisfy the requirements of multivariate statistical analysis (such as PCA), more measurement cycles than independent variations (or principal components) in chromatograms should be included in each moving time window. The number of independent variations (or principal components) in chromatograms is again application specific. In order to take advantage of multivariate smoothing effect, as many measurement cycles as practical should be included in each moving time window, as long as changes in peak shapes in each window are not significant. The extent of peak shape changes in a time window is again application specific.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An example of the method according to the present invention will now be described with reference to the accompanying drawing in which the sole FIGURE is a flow chart illustrating the method of the invention.

### DETAILED DESCRIPTION OF THE PREFERRED EMBODIMENTS

After the start of the gas chromatographic analysis of a process stream, a set of chromatograms from a predefined number of subsequent measurements (analysis cycles) is collected during a time window (step 1). The time window is made short enough to ensure there is little peak shape changes within this time window.

When the predefined number of chromatograms are collected, i.e. when the time window is ready (step 2), one of the chromatograms is automatically selected as a reference chromatogram (step 3). Any one of the chromatograms included in the time window can be selected as the reference chromatogram, although some statistics criteria can be used to select the most suitable chromatogram for the time window.

Each chromatogram in the window is aligned to the reference chromatogram by shifting the chromatogram along the time axis so that the best correlation between the chromatogram and the reference chromatogram is reached (step 4). This is possible because the time window is short enough to ensure there is little peak shape changes during this time.

A multivariate analysis, e.g. a principal component analysis (PCA), is performed on all the aligned chromatograms in the window to establish a multivariate data space for this window and to extract the systematic information from the chromatograms (step 5). Thus, the multivariate analysis leads to smoothed chromatograms with reduced noise.

Such a smoothed chromatogram of the last chromatogram aligned in the window in the reduced multivariate data space is now used to perform a peak analysis and to output the peak result (step 6).

The multivariate analysis further allows for detecting any chromatograms in the window with unexpected changes in peak shapes as outliers (step 7). In the case that such an outlier is detected, an alarm is generated to provide an early warning of a possible process upset or an analyzer malfunction (step 8).

At the end of the current measuring cycle, the algorithm waits for a new measurement. When a new measurement is received, the chromatogram from the oldest measurement is excluded from the set of raw chromatograms and the chromatogram from the new measurement is included, e.g. the time window is shifted by a measurement cycle (step 9).

The algorithm is then continued with the step 3 of selecting one of the chromatograms of the updated set of chromatograms as a reference chromatogram.

As a result of the invention, chromatogram alignment can be done much more efficiently in an embedded environment and the advantages of multivariate analysis are realized within each time window.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A method for processing chromatograms obtained by a process gas chromatograph in a plurality of subsequent measurements of one and the same process stream, said method comprising the steps of:
collecting a set of chromatograms from a predefined number of subsequent measurements,
selecting one of the chromatograms of the set as a reference chromatogram, aligning solely by cross-correlation and shifting each other of the collected chromatograms to the selected chromatogram,
performing a multivariate analysis on the aligned chromatograms to extract systematic information,
performing, on the basis of said information, a peak analysis on the latest chromatogram of the set and outputting the result of the peak analysis, and
for a new measurement, excluding the chromatogram of the oldest measurement from the set of chromatograms, including the chromatogram from the new measurement and continuing with the step of selecting one of the chromatograms of the set as a reference chromatogram.

2. The method according to claim 1, wherein an alarm is generated when the multivariate analysis reveals an outlier in the chromatograms.

3. A computer program product arranged for causing a processor to execute the method of claim 1.

4. A computer program product arranged for causing a processor to execute the method of claim 2.
